(19) United States
(12) Patent Application Publication
(10) Pub. No.: US 2010/0063975 A1
(43) Pub. Date: Mar. 11, 2010

(54) SCALABLE SYSTEM AND METHOD FOR PREDICTING HIT MUSIC PREFERENCES FOR AN INDIVIDUAL

(76) Inventor: Thomas J. HAYES, Westmont, IL (US)

Correspondence Address: Momkus McCluskey, LLC, 1001 Warrenville Road, Suite 500, Lisle, IL, 60532, US

(21) Appl. No.: 12/566,343

(22) Filed: Sep. 24, 2009

Related U.S. Application Data
(62) Division of application No. 11/253,421, filed on Oct. 19, 2005.
(60) Provisional application No. 60/620,582, filed on Oct. 20, 2004.

(51) Int. Cl. G06F 17/30

(52) U.S. Cl. 707/765; 707/779; 707/E17.014; 707/E17.017

(57) ABSTRACT

A system and method for creating and storing a user's hit-music preference list by receiving the user's biographical information, profiling the user based on the biographical information to determine music data that may be of interest to the user, receiving a rating from the user for a plurality of genres, wherein the music data is a member of one or more of the plurality of genres, and retrieving music data based on the user's rating for the plurality of genres. The system has a memory for storing the user's biographical information, a processor configured to profile the user based on the biographical information and to retrieve music data that may be of interest to the user, and a display unit for displaying the music data retrieved.

### RELATED APPLICATIONS

This application claims benefit of priority from U.S. patent application Ser. No. 11/253,421 filed on Oct. 19, 2005, which is the nonprovisional application of U.S. Provisional Patent Application No. 60/620,582, filed Oct. 20, 2004, the specifications and drawings of which are fully incorporated by reference herein.

### FIELD OF THE INVENTION

This invention relates generally to the field of computerized databases and more specifically to a scalable system and method for predicting hit music preferences for an individual.

### DESCRIPTION OF THE RELATED ART

In the sixty years since the end of World War II, tens of thousands of songs have entered the pop music archive. In the past, radio broadcasts, and to some extent television, were the predominant mechanisms for introducing music to the ever expanding American audience. Television played a greater role with the advent of music-format cable channels (such as MTV) in the early 1980s. Today, those in search of mass distributed music content can find it on radio, television and the Internet. With the emergence of digital media players, like Apple's famous iPod®, millions of people, consumers young and old, are rushing to replace their existing libraries of recorded music (originally transcribed on compact disc, cassette or vinyl record) with digital music files in a variety of formats—MP3, WMA, AAC, AIFF, WAV, and others.

Over the years, each generation has had its share of favorite hits, born from a diverse variety of music genres (style categories)-big band, pop standards, jazz, blues, rockabilly, country and western, rock and roll, folk, soul, disco, reggae, modern rock, rap, etc. In the library of American pop music, some hits are timeless, some are momentary blips on national radar and others are obscure wonders, alive only in the memories of their creators and a small group of profoundly impressed fans.

There exists now a wide availability of access to a great number of these songs from outlets like “oldies” format radio stations, Internet music downloads and legacy publishing catalogs (distributed via optical compact disc from traditional brick and mortar retail outlets and Web stores such as Amazon.com). This marketplace reality has exposed the “hits of yesterday” to today's young audiences. At the same time, an older generation of consumers, people in the forty to sixty years age group, is realizing that they might enjoy their favorite songs a lot more if they had them in digital format for use on the new wave of small-form players.

The transformation to the digital world has introduced two basic challenges to the music-consuming public: 1) What is the best way for digital file-sharing technology to acceptably co-exist with the rights of music creators and publishers? and 2) What is the best method for helping consumers identify preferred songs, locate those songs as digital file objects, compile personal lists of songs, sample selected song excerpts and ultimately purchase digital music files?

Some Internet-based music stores offer over 2 million songs in digital format for downloading. However, it is unlikely that any person, no matter how avid a music lover, would listen to all 2 million songs. At an average duration of 3 minutes each, 2 million songs equates to one hundred thousand (100,000) hours—or 11.41 years. Millions of music collectors, the recorded music industry and their potential customers would be better served by a more realistic quantification of the music catalog.

A more manageable comprehension can be mathematically deduced by focusing on the small percentage of songs that have been established as legitimate “hits;” with hits defined as recordings that have achieved a wide degree of exposure, and demonstrated a high level of audience popularity through sales statistics and cultural persistence.

To begin the process of quantifying songs that can be described as hits, it is important to understand that in the minds of millions of people, the literal perception of their great American hit music catalog is decidedly different from their neighbor's recollection. In other words, one person's hits may not be the same as the next person's hits, especially if the next person is from a different generation, economic status or cultural background. In the absence of a highly intuitive procurement method, knowing how to locate songs that they've never heard of can be frustrating for members of any generation.

Billboard Magazine has been publishing hit music charts for decades. These charts, sometimes in combination with data apparently based on the store's ability to license music from the catalogs of the four major record labels, are typically used by Internet-based music stores to sell digital downloads and monthly music subscriptions. Digital music stores have implemented search technologies which, while they may be viewed as improving each year, are still not as intuitive and effective as some consumers might hope for—especially when tasked with pleasing shoppers from multiple generations. Prior art searching capabilities generally describe methods or systems that propose play list queries that are formulated using declared user preferences, music sampling, collaborative filtering, meta data monitoring, and acoustic waveform analysis.

Declared user preferences are systems that provide a mechanism for collecting user input and associating user “voting” (usually on a pre-determined scale) with a plurality of fields, each field relating in some way to a song's characteristics: music genre (a category or label used to describe a style of music—classical, jazz, rock, country, disco, etc.), tempo, artist name, instrumental components (piano, harp, guitar-based compositions), etc. With this method, songs can be included or excluded from play lists based on the users' (human classification) vote.

Music sampling systems include a mechanism for allowing the user to select and (through hardware or computer-based media players) physically sample audio excerpts of a particular song or song genre, and then input the user's response to that song or genre in some type of ranking order-usually rating songs or genres as “Strongly Approve”, “Moderately Approve”, “Moderately Disapprove”, “Strongly Disapprove” or “No Opinion”. With this method, play list songs (as a labeled genre) can be included, excluded and ordered by preference level based on the users' assigned rank.

Collaborative filtering systems attempt to predict Individual A's affinity for a particular song by showing Individual A—a list of songs selected by Individual B or C, when Individual B or C also chose the song Individual A has selected or highlighted. With this method, songs are casually recommended to the user based on the presumed opinions of other users.

Meta data monitoring systems maintain a record of the user's song play back habits and then creates recommended play lists by evaluating the statistical results obtained by monitoring data embedded in digital audio entities (songs) like: USER_UPDATE_TIME; USER_RATING; USER_PLAYCOUNT_TOTAL; USER_LAST_PLAYED_TIME, etc. With this method, songs are logged and recommendations to the user are based on the user's history with respect to his playback decisions for specific songs.

Acoustic waveform analysis is a digital signal processing (DSP) method that proposes to associate the likelihood of an affinity match between Song A and Song B by comparing the acoustic fingerprint of Song A with the acoustic fingerprint of Song B or other songs in a database. With this method, songs can be included or excluded from matching play lists based on the song's unique musical and vocal composition as measured by wave form evaluation or song-specific audio frequency analysis.

The basic and more elaborate techniques explained here highlight the history of modern database programmed music search. While the methods described above are quite acceptable and can assist consumers in looking for a variety of songs, no single method is as effective as a blended combination of the most efficient available methods.

The user in search of his or her songs may not want to be limited to digital downloads and collaborative play lists. They may want the freedom to remember the music, to identify the songs, and to acquire the recordings in any format available.

For example, music collectors may want to receive query results that help them search auction sites, such as EBay®, for classic vinyl albums not listed in conventional on-line music stores. Prior art that concentrates primarily on Web stores and the distribution of songs and song play lists over computer networks may be disenfranchising a sizable market of the music audience. A truly valuable system and method for the selection of music should include a means of serving every segment of the potential market regardless of age, cultural background or income status.

The search technology used in some Web stores, though functional, is customarily limited to giving users a mix of standard search methods: Title search, Artist search, Album search, Music type (genre) search, Keyword search, Collaborative filtering (the method of displaying choices by showing selections made by other users), Search by Style (displaying songs with similar music styles or dance influences) and Search by Era (listing songs from a particular decade).

These basic query methods, while serviceable and used by most music catalog search engines, are not particularly intuitive and do not by design possess any intrinsic knowledge of the individual's demographic details that could be blended with other queries to create richer, consumer-specific queries.

Title search, Artist search, Album search, Music Type search and Keyword search are all well-established methods of finding targeted tracks in a music database; however, on their own, these queries tend to be quite broad in their results and can sometimes make it difficult to quickly identify a specific song.

Because the majority of users building a master list of their favorite songs may have as many as two-thousand (2,000) or more potential tracks, specific title searches are not an efficient way to generate comprehensive personal play lists. It would be next to impossible for the average consumer to recall the name of every hit song they've ever encountered.

The same can be said for artist queries. A consumer may recognize that he or she enjoys the music of artists like Frank Sinatra or U2, but it is doubtful that any user will like every song by anyone artist. Meanwhile, album queries produce results that often include one or two songs the consumer wants to locate, and eight more they do not want.

Keyword queries that deliver results based on a phrase or part of a word are helpful but possibly too vague. For example, if a user were to initiate a Keyword search for the phrase ‘john” in a standard artist lookup box, the query returned would be likely to include artists like Elton John, Johnny Cash, Olivia Newton-John, Johnny Rivers and John Coltrane, who may have different styles of music.

Database queries that display results grouped by music genres can be a fast way to generate potential play lists, but some genre categories can have many thousands of songs. As an example, a music genre like “soul” may be expected by some consumers to contain a wide-ranging style of music from legendary hit music artists such as Diana Ross and the Supremes, Jerry Butler and James Brown. However, the soul genre is very broad and could produce many thousands of possible songs. Without a method of sub-classification, genre filtering is not extremely efficient at delivering granular search results.

Collaborative filtering, while certainly interesting, does not guarantee the consumer will enjoy the music selections as purchased by “others”, because traditional collaborative filtering techniques do not generally construct a profile for each user and then show collaborative picks matched to like-minded users. As such, collaborative filtering remains a handy technique in the recommendation toolkit, but there is not an easy way to verify its accuracy.

Search by Style (displaying songs with similar music styles or dance influences) can be a welcome method for assisting consumers; however, to be effective it must generally be combined with other methods. For example, users querying a catalog for music in the style of “swing” might locate songs that represent a style of 40s era big band swing, but by adding a Search by Era filter (for songs since 1990), the query could produce tracks limited to a more modern (and slightly faster) interpretation of the swing genre.

Another seemingly sensible way to group song queries (searches) might be to offer members of each generation lists of songs corresponding to the hit-music of their youth. But this Search by Era method, when used alone, cannot be considered extremely efficient because many users will continue listening to hit music well past their formative teenage years. And, young people in 2005 cannot be reasonably expected to restrict their hit music preferences to today's new music tracks.

A discussion of user declared preferences and sampling was disclosed in Kolawa, et al. (“Kolawa”), U.S. Pat. No. 6,370,513, entitled “METHOD AND APPARATUS FOR AUTOMATED SELECTION, ORGANIZATION, AND RECOMMENDATION OF ITEMS.” The Kolawa patent discloses “[a]n automated recommendation system keeps track of the needs and preferences of the user through a user preference vector”. As a music recommendation system, Kolawa is deficient because it seems to rely heavily on “sampling” and user preferences as its predominant means of recommending items.

The prior art disclose methods of song prediction which, III addition to collaborative filtering, include human classification techniques, track playback metadata monitoring, and various forms of acoustic waveform analysis. Plastina et al. (“Plastina”), U.S. Pat. No. 6,941,324, entitled “METHODS AND SYSTEMS FOR PROCESSING PLAYLISTS,” discloses a method for metadata monitoring the user playback experience by keeping statistical data on parameters such as user_update_time, user_rating, user_last-played_time, and user-playcount_total.

This proposed method has some inherent disadvantages. This system requires each user to have some degree of established track record. If an individual user has little or no “uptime” experience using monitored parameters, it may be difficult for the system to reliably predict songs intended to enhance the user experience. Also, since metadata monitoring tracks usage of songs (digital object entities) played within a software instantiated (created) media player, two different users could log on to the same media player at different times; and in choosing different songs, each user could possibly affect the monitoring statistics which may or may not be distinguishable as being associated with the playback patterns of specific users on the same media player.

Similarly, methods such as DSP (digital signal processing) analysis and acoustic waveform analysis make assumptions based on science that measures the mapping of musical properties or the actual acoustic “fingerprint” of songs. This may give the database programmer a good picture of a song's musical composition, and therefore the ability to identify songs with similar acoustic fingerprints, but may not include any way to measure the literal content meaning of a specific song.

In the big picture, listeners (users) are likely to develop a strong affinity for hit music based on the intersection of several contributing factors: a) how often they were exposed to a specific song; b) the age of the listener when they were exposed to the song; c) the reaction of peer group members to that song; d) the way the song sounds (a combination of vocal performance, musical design and musical instruments-lofty violins, gentle guitars, or punctuating drums); e) the literal message content of the song. These factors illustrate the apparent deficiencies of DSP or acoustic waveform analysis systems because of their inability to measure, evaluate or extract any information on a user's affinity to hit music using “message content,” for example, as one form of affinity evaluation.

Therefore, there is a need in the art for a system and method that provides a multiple cross-indexed query resource threads grounded in a combination of user-specific profile information and song-specific attribute data. Such a system would provide a simple forms-based music database capable of “suggesting” songs to a user by leveraging an almost biographical knowledge of a user's history and music genre preferences with a cross-linked catalog optimized for displaying the obvious (and not so obvious) connections between hit-music songs. Such a system and method would allow the user to assemble and maintain these personal play lists on his or her computer.

### BRIEF DESCRIPTION OF THE DRAWINGS

The exact nature of this invention, as well as the objects and advantages thereof, will become readily apparent from consideration of the following specification in conjunction with the accompanying drawings in which like reference numerals designate like parts throughout the figures thereof and wherein:

FIG. 1 is a flow chart depicting a method for entering biographical information and query settings according to one embodiment of the present invention.

FIG. 2 illustrates an exemplary biographical information form according to one embodiment of the present invention.

FIG. 3 illustrates an exemplary catalog statistics thread according to one embodiment of the present invention.

FIG. 4 illustrates an exemplary attribute matching thread according to one embodiment of the present invention.

FIG. 5 illustrates an exemplary editor suggestions thread according to one embodiment of the present invention.

FIG. 6 illustrates an exemplary profile baseline thread according to one embodiment of the present invention.

FIG. 7 illustrates an exemplary declared preferences thread according to one embodiment of the present invention.

FIG. 8 illustrates an exemplary summary of a query search according to one embodiment of the present invention.

FIG. 9 is a flow chart depicting a method for retrieving music data according to one embodiment of the present invention.

FIG. 10 is a flow chart depicting a method for deciphering music data based on user's genre rating in accordance to one embodiment of the present invention.

FIGS. 11 A-C illustrate an exemplary list of genre to rank according to one embodiment of the present invention.

FIGS. 12 A-B illustrate an exemplary universal personal music profile that can be shared with music vendors and others on a computer network, according to one embodiment of the present invention.

### SUMMARY OF THE INVENTION

The method and system of the present invention provides individualized query searches based on a user's biographical information. A user wishing to locate his favorite hits, from within a published or on-line catalog of hit songs, can benefit from a system designed to allow users to better describe their unique history and preferences to narrow their field of search. The present invention provides such a system capable of identifying and predicting specific songs that may be of interest to the user.

One embodiment of the present invention provides a system capable of developing a user profile with or without the inclusion of a user's sampled preferences. The system can be implemented in computer software or accessed through a network such as the Internet. The computer software can have compatible open database connectivity (ODBC) that enables the user to identify, save, share and shop for music data with commerce systems managed by other platforms.

One method that embodies the present invention involves directing the user to complete a biographical information form that creates a unique user identity and associated hit-music preference list. The form may include login information, gender, income level, education level, age or year of birth, marital status and tolerance of song themes.

One embodiment of the present invention provides a system that creates and stores a user's primary exposure window (PEW) based on the user's year of birth, wherein each user's hit-music preference list is based, in part, on a theoretical time frame associated with the period in the user's life when he is most likely to hear, absorb, and develop an emotional connection with popular music.

One embodiment of the present invention provides the user with multiple cross-indexed query resource threads such as catalog statistics, attribute matching, editor suggestions, profile baseline, and declared preferences. The system can offer suggestions for music data based on any of several threads individually, or any variable combination of user determined multiple cross-indexed threads. One embodiment of the present invention allows the user to utilize the biographical information with PEW logic and other query resource threads to filter music data and suggest a hit-music preference list for the user.

One method embodying the present invention involves profiling the user based on information entered, such as biographical information and search query settings. Profiling may be in the form of customizable or predetermined search parameters that depend on the information inputted by the user. The system then retrieves a list of music data depending on the user's profile via filtering mechanisms. The music data can be retrieved from a local or remote database. The remote database can have a cross-platform interconnectivity network conforming to open database connectivity standards.

One method embodying the present invention includes rating a plurality of genres by completing a genre rating form. The genre rating form includes genre classifications such as swing, techno, pop, rock, soul, disco, country, classical, jazz, and Latin and others. In one embodiment, the genre rating form only displays relevant genre classifications found within the user's PEW. Rating of genre classifications allows the software program to retrieve filter music data based on user's genre preference.

### DESCRIPTION OF THE PREFERRED EMBODIMENT

Methods and systems that implement the embodiments of the various features of the invention will now be described with reference to the drawings. The drawings and the associated descriptions are provided to illustrate embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment. Throughout the drawings, reference numbers are re-used to indicate correspondence between referenced elements. In addition, the first digit of each reference number indicates the figure in which the element first appears.

The present invention provides individualized query searches based on a person's biographical information. In one embodiment, the system is capable of developing a user profile with or without the inclusion of a user's sampled preferences. In another embodiment, the query resource threads can be cross-indexed. The system allows the user to actively determine which combination of query resource threads he or she wishes to include or exclude, thereby providing a more intuitive, more flexible, and more responsive system to the user's needs.

The system can be implemented in computer software, hardware, or accessed through a network such as the Internet. In one embodiment, the computer software has compatible open database connectivity (ODBC) that enables the user to identify, save, share and shop for music data. For example, Microsoft Access® is an ODB-compliant software product that can be used to communicate with other ODBC-compliant databases across networks, even with those that utilize different operating systems and platforms (and one embodiment of the invention disclosed here could be implemented in Microsoft Access).

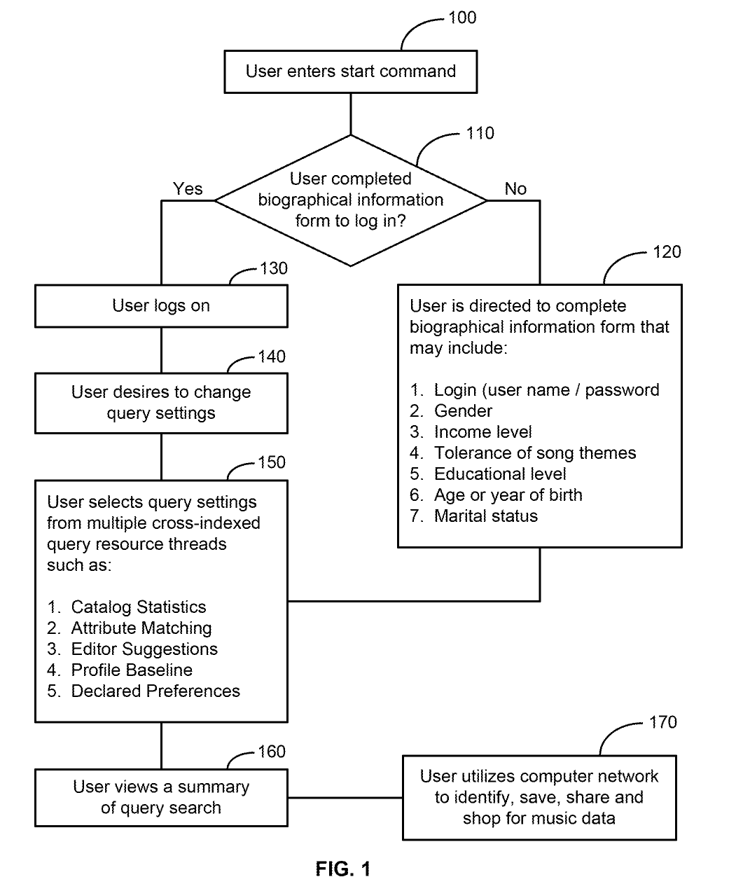

FIG. 1 is a flow chart depicting a method for entering biographical information and query settings according to one embodiment of the present invention. Initially, a user enters a start command (100). If the user is using a computer program, the start command will open or start the program. If the user is using an Internet-based system, the start command will retrieve or open the relevant Web site. In either case, the user may be required to enter login information such as a username and/or password. It can be envisioned that the system automatically identifies the user, for instance, by logging on to Windows® operating system, or is stored for future access by the computer program.

Access to the system depends on whether the user completed a biographical information form (110). If the user is using the system for the first time, the user will be directed to complete a biographical information form (120). The form may include login information, gender, income level, education level, age or year of birth, marital status, tolerance of song themes and other categories. Tolerance of song themes is used to ascertain the scope of the user's music preferences by evaluating the user's positive or negative reaction to specific types of common song content themes, such as violence, sexual infidelity, political messages, etc.

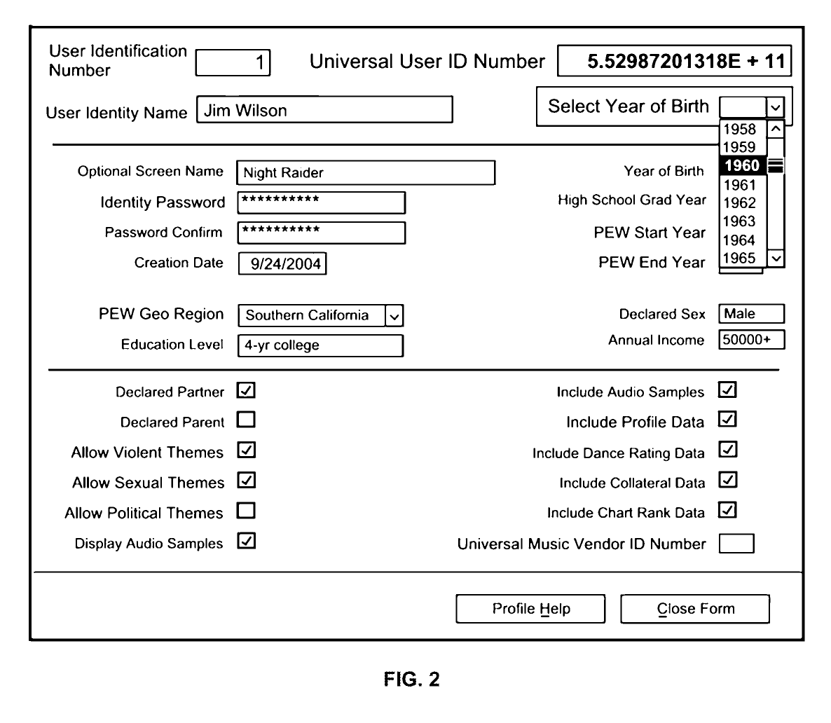

In one embodiment, the system creates and stores a user's primary exposure window (PEW) based on the user's year of birth, wherein each user's hit-music preference list is based, in part, on a predetermined time frame associated with the period in the user's life when he is most likely to hear, absorb, and develop an emotional connection with popular music. For instance, the predetermined time frame window can be between age 12 and age 34. FIG. 2 illustrates an exemplary biographical information form according to one embodiment of the present invention.

A “hit” song or music, as referenced herein, generally applies to music data that has been disseminated to a mass audience via repetitive distribution to a series of local and network radio outlets, television, Internet, and/or written articles. These “hit” songs are commercially popularized by virtue of their inherent content appeal, musical/vocal sound, repetitive audience exposure and deliberate marketing.

A hit-music preference list can be an organized inventory of accessible music data or a collective universe of a person's hit-music memories—an individual's “personal soundtrack.” An individual's personal soundtrack cannot be quantified simply by title, artist and music type. People of any age or any sex can love all kinds of music from country to rock, disco to jazz, soul to swing. A personal soundtrack is something that is created over time, and remembered through the filter of one's life experiences. An individual can have an emotional connection with their favorite music. And that connection can influence attitudes, awareness and commercial transactions.

Referring back to FIG. 1, if the user has completed the biographical information form in the past, the user can immediately log on (130) by entering username and password.

Once the user has completed the biographical information form (120), the user may then select search query settings for multiple cross-indexed query resource threads (150). A user who has completed the biographical information form in the past and has logged on (130) to the system, may also desire to change or adjust search query settings (140).

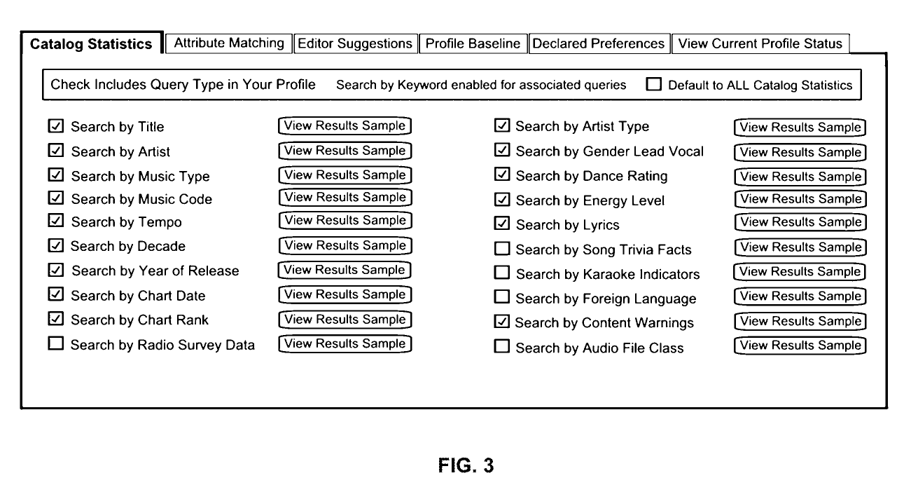

In one embodiment, the user has multiple cross-indexed query resource threads such as catalog statistics, attribute matching, editor suggestions, profile baseline, and declared preferences. Catalog statistics data is information compiled from published or licensed documentation providing a historical overview of hit music including data such as chart rankings, date of release, song tempo, music genre, energy level, etc. FIG. 3 illustrates an exemplary catalog statistics thread according to one embodiment of the present invention.

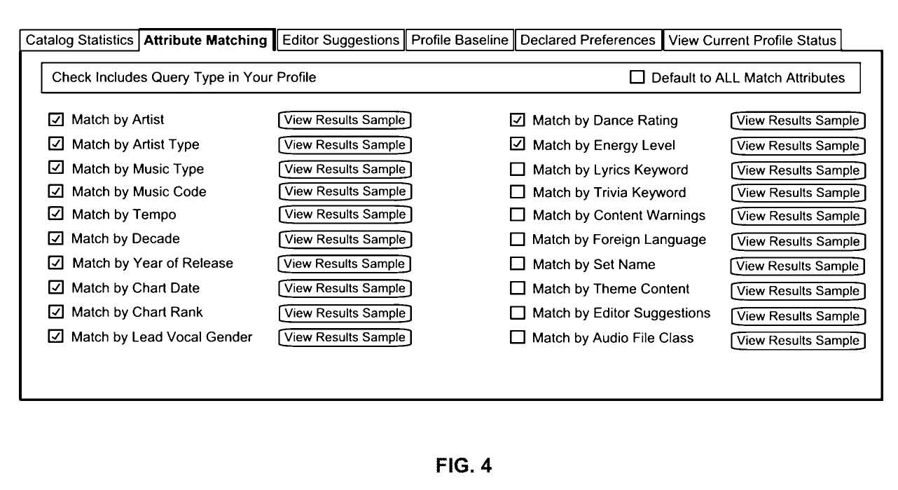

Attribute matching invokes filter options that suggest music data by allowing a user to take advantage of the natural connection between songs-same artist, same music genre, same tempo, same dance rating, gender of lead vocal artist, etc. FIG. 4 illustrates an exemplary attribute matching thread according to one embodiment of the present invention.

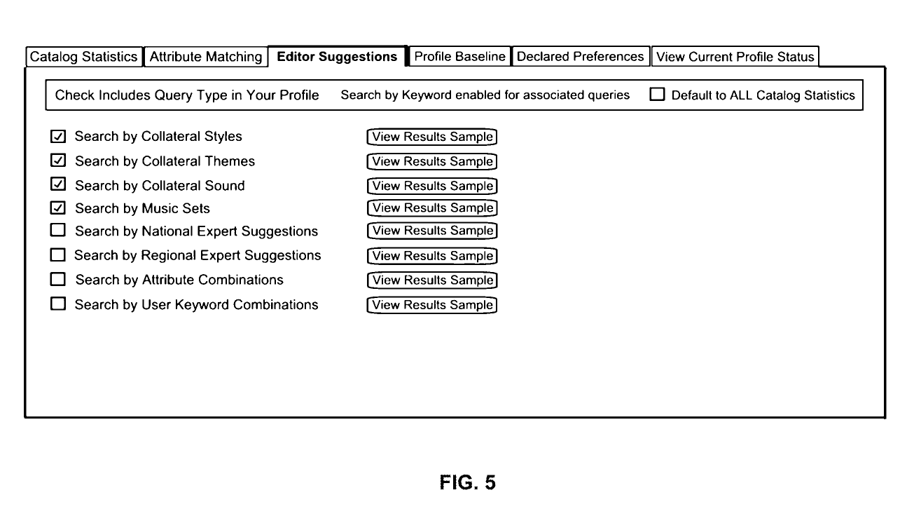

Editor suggestions are queries that recommend music data based on expert opinions like the grouping of songs into pre-defined “sets,” such as “Beach Party Fun”, “Jukebox 60s”, and “Male Rock Classics.” It also includes collateral suggestions based on perceived music styles, such as calypso beat, country, western swing, twist, tango, two-step, and waltz. Furthermore, this thread allows query search for thematic and song message content, for instance, themes like financial hardship, medical conditions, infidelity, or crime sprees. FIG. 5 illustrates an exemplary editor suggestions thread according to one embodiment of the present invention.

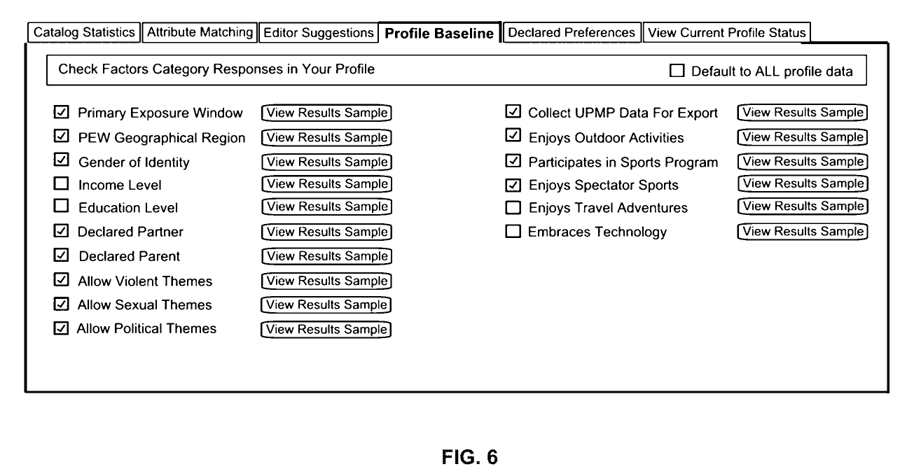

Profile baseline contains the biographical information entered by user (120) prior to accessing the system. It contains data such as user's year of birth, sex, income level, education level, marital status and PEW classification. FIG. 6 illustrates an exemplary profile baseline thread according to one embodiment of the present invention.

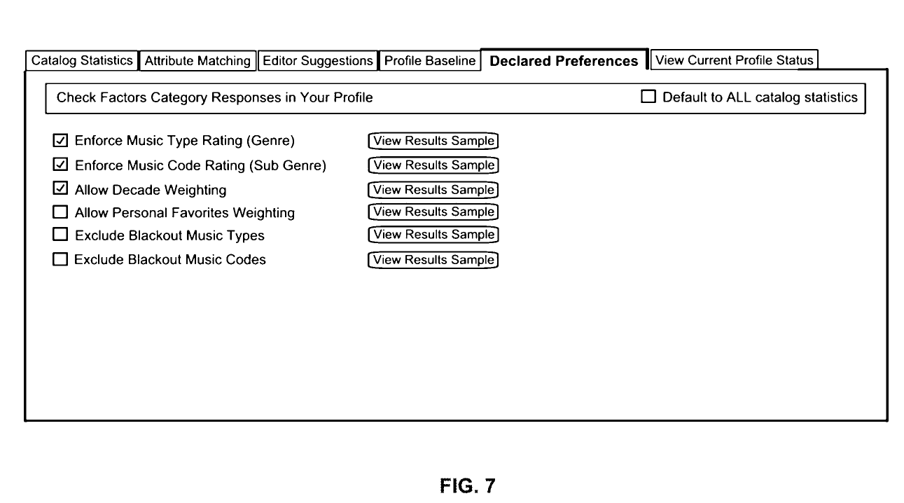

Declared preferences give the user the option to include or exclude particular music data or genre based on the user's decision. FIG. 7 illustrates an exemplary declared preferences thread according to one embodiment of the present invention.

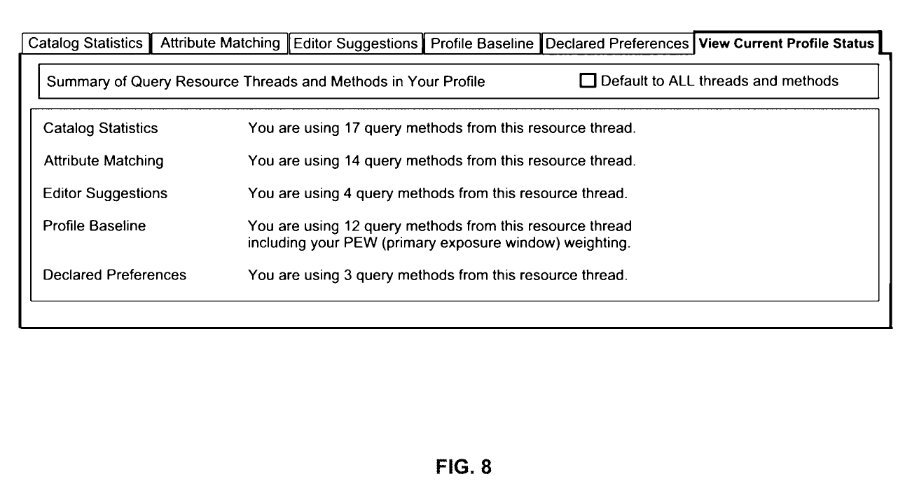

The system can offer suggestions for music data based on any of several threads individually, or any variable combination of multiple cross-indexed threads. For instance, the baseline profile thread can be used solely to suggest hit-music preference list within the PEW classification parameters. Another example, all threads can be selected to provide a narrower search or multiple search results. Once the search query settings are selected, the user may view a summary of the query search (160). The retrieved music data may be in the form of song title, artist, tempo, decade, year of release, chart rank, chart date, energy level, gender of the lead vocalist, audio, video and lyrics. FIG. 8 illustrates an exemplary summary of a query search according to one embodiment of the present invention.

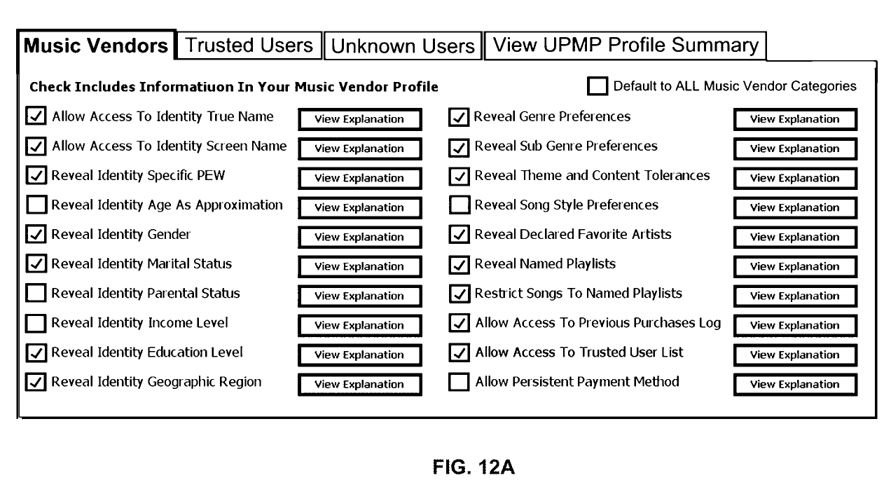

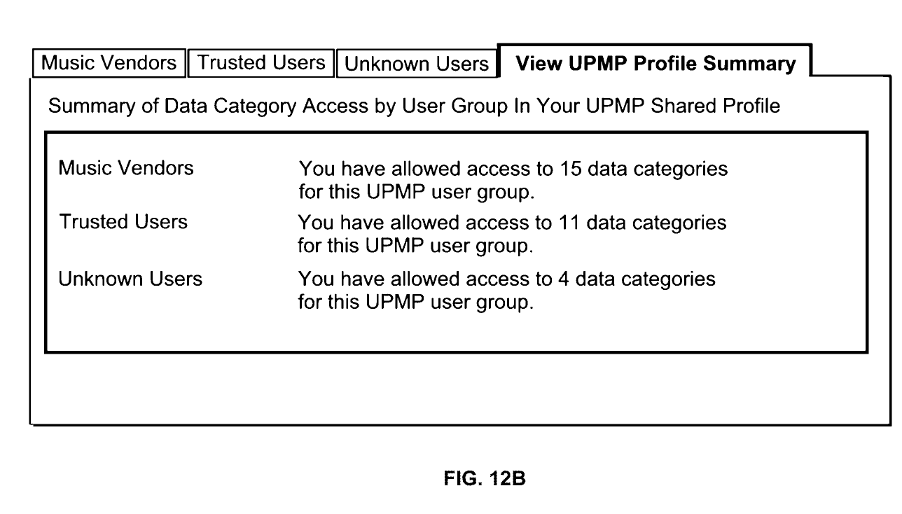

In one embodiment, the user can utilize a computer network in combination with ODBC capability and maintenance of a “universal personal music profile” (UPMP) standard to identify, save, share and shop for the retrieved music data (170). The embodiment might specify a UPMP standard that includes, at a minimum, a series of baseline statistics uniquely associated with an individual user, such as age, sex, gender, marital status, economic status, residence or PEW-related geographical region, and a measurement of the user's tolerance of song content themes (such as violence, sexual storylines or political messages). FIGS. 12 A-B illustrate an exemplary universal personal music profile that can be shared with music vendors and others on a computer network, according to one embodiment of the present invention.

Another embodiment might implement the UPMP standard as a unique user profile stored and transported on a hardware-based digital media player (like the Apple iPod®) or some type of compact portable media (such as SD Card, SmartCard, Memory Stick, CompactFlash® or USB Flash “thumb” media). In this embodiment, the user might insert his compact media into a digital music duplication device (a “build your own music kiosk”) that may be offered at “brick and mortar” retail stores subscribing to the UPMP standard. In this manner, the user's universal personal music profile could be accessed via the compact media interface on the retail “kiosk,” and the retail kiosk might then suggest a play list for the user, based on the UPMP information stored on the user's compact media. The user can then approve the selection of music files on the kiosk display interface, and the in-store kiosk would create a custom music CD, CompactFlash®, or iPod®-like download accordingly.

Not every recorded song associated with specific music data is available in digital format. Some music data may only be obtainable in tape cassette or vinyl record format. The user in search of his or her personal soundtrack may not want to be limited to digital downloads and collaborative playlists. He or she may want the freedom to identify, save, share and shop for the retrieved music data in any format available.

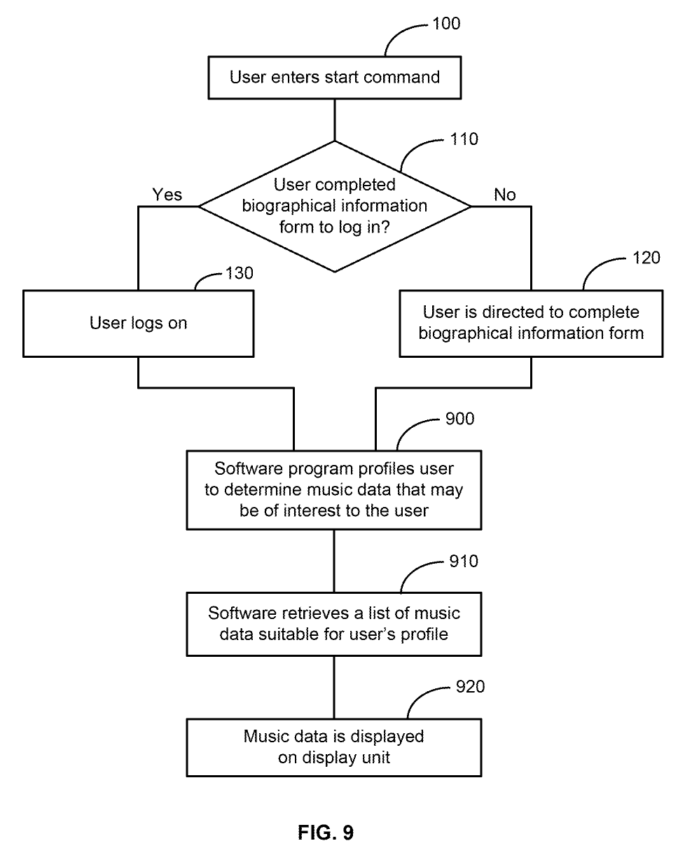

FIG. 9 is a flow chart depicting a method for retrieving music data according to one embodiment of the present invention. As explained earlier, the user initially enters a start command to open the software or internet-based system (100). If the user completed biographical information form (110), then the user can log on (130); otherwise, the user will be directed to complete biographical information form (120).

Once the user has gained access to the system, the software profiles the user to determine music data that may be of interest to the user (900). Profiling may be in the form of customizable or predetermined search parameters that depend on the biographical information inputted by the user. For example, customizable search parameters may include user settings for query threads such as catalog statistics, attribute matching, editor suggestions, profile baseline, and declared preferences. Predetermined search parameters can be any parameter programmed in the system that may depend on the inputted biographical information. For instance, PEW parameters are based on the user's year of birth and would prompt the system to suggest music data within a theoretical time frame window.

Next, the system retrieves a list of music data depending on the user's profile (910) via filtering mechanisms. The music data can be retrieved from a local or remote database. The database can have a fully integrated hit music catalog with multiple cross-indexed records. The local database can be stored on any storage medium such as a CD, DVD, CompactFlash® card or computer hard disk. The remote database can be retrieved through a network system, such as the Internet. To have remote database capability, a person skilled in the art would know that the system should have a cross-platform interconnectivity network conforming to open database connectivity standards. The retrieved music data (910) can then be displayed on a display unit (920). Music data such as audio or video data can then be played on media players, such as Windows Media Player®.

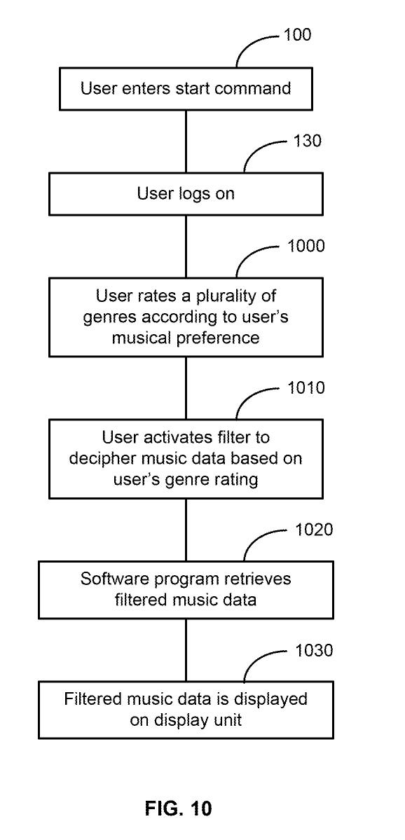

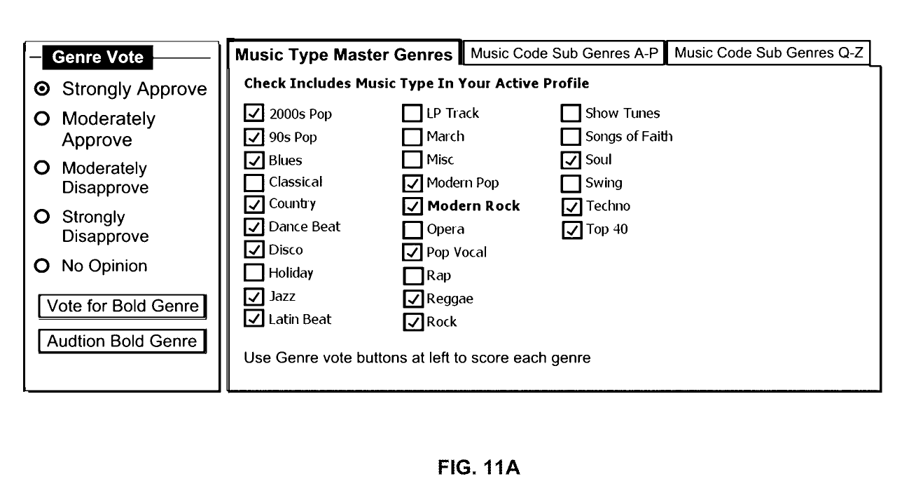

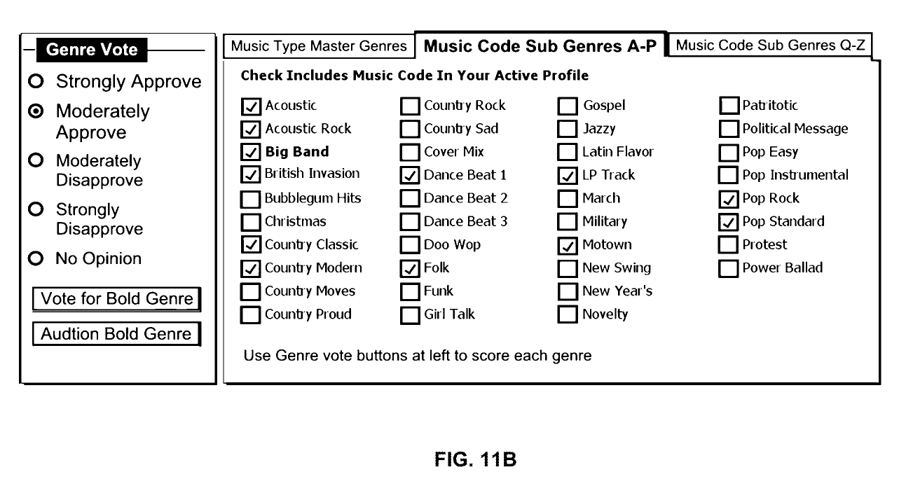

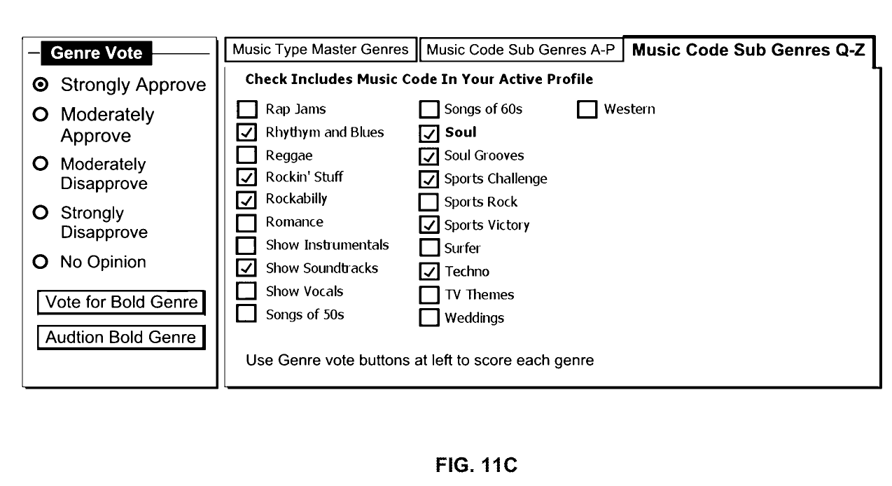

FIG. 10 is a flow chart depicting a method for deciphering music data based on user's genre rating in accordance to one embodiment of the present invention. The user first enters start command (100), then logs on to the system (130). Once the user accesses the system, the user can open a genre rating form. In one embodiment, the user can activate or deactivate PEW filtering. The genre rating form includes genre classifications such as swing, techno, pop, rock, soul, disco, country, classical, jazz, and Latin. In one embodiment, the genre rating form only displays relevant genre classifications found within the user's PEW. FIGS. 11 A-C illustrate an exemplary list of genre to rank according to one embodiment of the present invention.

Referring back to FIG. 10, the user rates the displayed genres according to the user's musical preference (1000). By ranking the genre classifications, the user activates or deactivates a filter that deciphers music data based on user's genre rating (1010). This is because music data can be a member of one or more genre classifications. The software program then retrieves filtered music data (1020) from a local or remote database. In one embodiment, the ranking of the genre classifications prompts the software to retrieve music data (1020) in the same genre order as user's genre ranking. Finally, the filtered music data (1020) can then be displayed on a display unit (1030).

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described preferred embodiment can be configured without departing from the scope and spirit of the invention. Therefore, it is to be understood that, within the scope of the appended claims, the invention may be practiced other than as specifically described herein.

I claim:

1. A method for creating a music preference list for a user, the method comprising the steps of:
storing, on a memory of a computer, a user profile form, the user profile form including a plurality of biographical fields for the user to complete and a plurality of query types for the user to select, the query types including a primary exposure window query type which selects those pieces of music which have release dates within a calculated window of time, the window having a beginning year and an end year;
using a processor of the computer to present to the user, on a display associated with the computer, the user profile;
completing, by the user, at least some of the biographical fields, the user enabled to select ones of the fields for his or her completion and enabled to omit the completion of others of said fields;
receiving, as one of the biographical fields, the birth year of the user;
selecting, by the user, at least some of the query types on the user profile form, the user enabled to select some or all of the query types and to deselect others of the query types;
forming, by a processor of the computer, from the completed biographical fields and selected query types, a customized query for application against at least one music database, the customized query being uniquely associated with the user;
responsive to the user selecting the primary exposure window query type, responsive to the user entering his or her birth year, and as a substep of said step of forming the customized query, creating the primary exposure window based on the birth year of the user, the processor calculating, based on the birth year of the user and a predetermined and stored first age, the beginning year of the primary exposure window, the processor calculating, based on the birth year of the user and a predetermined and stored second age, the end year of the primary exposure window;
at a first time, storing the customized query;
at a second time following the first time, retrieving the customized query;
applying the customized query against said at least one music database, the database containing a plurality of records each associated with a respective piece of music, each record including a year of release; and
retrieving a plurality of music records having years of release which fall within the primary exposure window.

2. The method of claim 1 further comprising the steps of:
receiving a rating from the user for each of a plurality of genres, wherein ones of the music records are members of one or more of the plurality of genres;
storing the user's ratings of the genres;
incorporating the user's ratings into the customized query; and
using the customized query to retrieve music records based on the user's rating for the plurality of genres.

3. The method of claim 1, further comprising the step of providing a cross-platform interconnectivity network by conforming to open database connectivity standards permitting development, for web sites or computer systems.

4. The method of claim 1, wherein the selected query types are multiple query resource threads that are cross-indexed.

5. The method of claim 1, wherein the query types include legacy catalog statistics, attribute matching, editor suggestions, profile baseline, and declared preferences.

6. The method of claim 1, further comprising the step of combining multiple cross-indexed query types to produce the customized query.

7. The method of claim 1, and further comprising the steps of:
at the first time, storing the customized query on a removable, user-transportable medium;
traveling from a first location at which said computer is situated to a second location at which the user may access at least one music database;
at the second location, connecting the user-transportable medium into a device through which said at least one music database may be accessed; and
using the device to retrieve the customized query at said second time from the user-transportable medium.

8. The method of claim 1, further comprising the substep of creating a personal profile, the personal profile having a Universal User Identification Number that uniquely associates the user with the customized query.

9. A system for creating a music preference list for a user, the system comprising:
a first memory for storing a user profile form, the user profile form including biographical fields for receiving biographical data of the user and a plurality of user-selectable query types, the biographical fields including a birth year of the user, the query types including a primary exposure window; and
a processor connected to the first memory, a display for displaying the user profile form and a graphical user interface for inputting information into the user profile form, the processor prompting the user to enter data into ones of the biographical fields selected by the user and prompting the user to select one or more of the query types, the processor forming, responsive to the user entering his or her year of birth and selecting the primary exposure window query type which selects pieces of music which have release dates within a calculated window of time, the primary exposure window having a beginning year and an end year, the processor calculating the beginning year as a function of the user's year of birth and a first, predetermined age, the processor calculating the end year as a function of the user's year of birth and a second, predetermined age, the processor storing, in a second memory connected to the processor, a customized query uniquely associated with the user and defining search criteria formed from the selected query types and at least some of the biographical fields;
the customized query retrievable from said second memory and applicable against at least one music database containing a plurality of music records, the customized query operable to retrieve ones of the music records which satisfy the search criteria, the processor assembling the music preference list from the retrieved ones of the music records.

10. The system of claim 9,
wherein the customized query stores a rating from the user for a plurality of genres, records in said at least one music database being identified by genre; and
wherein the processor is programmed to retrieve music records based on the user's rating for the plurality of genres.

11. The system of claim 10, wherein the plurality of genres is selected from a group consisting of swing, techno, pop, rock, soul, disco, country, classical, jazz, blues, opera and Latin.

12. The system of claim 9, wherein the query types further include query types which are selected from a group consisting of title, artist, tempo, decade, year of release, chart rank, chart date, energy level, gender of the lead vocalist, audio, video, music type, artist type and lyrics.

13. The system of claim 9, wherein further ones of the biographical fields are selected from a group consisting of age, gender, race, education level, income level, marital status and geographical location.

14. The system of claim 9, wherein the customized query is a personal music profile compatible with each of a plurality of searchable electronic databases offered by music vendors.

15. The system of claim 14, further comprising a Universal User Identification Number that uniquely associates the personal music profile with the user.

16. The system of claim 15, wherein the music vendors, trusted users, or unknown users have access to information in the personal music profile beyond the Universal User Identification Number.

17. The system of claim 15, further comprising at least one information category in the personal music profile, the personal music profile selectively allowing the user to permit or deny access to the at least one information category.

18. The system of claim 17, further comprising data from the at least one information category, the data being selectively shared with at least one user type selected from the group consisting of Music Vendors, Trusted Users, and Unknown Users.

19. The system of claim 17, wherein the at least one information category is selected from the group consisting of Identity True Name, Identity Gender, Identity Marital Status, Identity Income Level, Identity Parental Status, Identity Education Level, Genre Preferences, Theme and Content Tolerances, Favorite Artists, Named Playlists, Previous Purchases History, and Payment Method.

20. A customized query stored on a machine-readable medium, the query comprising:
a plurality of stored fields of biographical information uniquely identifying the user, the stored fields having been selected by the user from a plurality of possible fields of biographical information, the fields of biographical information including the birth year of the user; and
at least one stored user-selected query type establishing a search criterion for application against a music database containing a plurality of music records, said at least one stored user-selected query type having been selected by the user from a plurality of possible query types, the possible query types including a primary exposure window query type which selects those pieces of music which have release dates within a calculated window of time, the window having a beginning year and an end year;
the customized query usable by a database searching software application to search at least one music database containing a plurality of music records, the customized query causing the software application to retrieve ones of the music records which satisfy the search criteria defined by the customized query, the customized query including, responsive to the user entering his or her birth year and selecting the primary exposure window query type, a primary exposure window query in which the beginning year has been calculated as a function of the birth year of the user and a predetermined first age and in which the end year has been calculated as a function of the birth year of the user and a predetermined second age, the customized query, when applied to a music database, returning records of music having release dates which are within the primary exposure window.

21. The query of claim 20, wherein the machine-readable medium on which the customized query has been stored is user-transportable, the customized query created at a first location, the customized query usable by a database searching software application at a second location remote from the first location, the customized query adapted to be coupled to the music database by the database searching software application to retrieve ones of the music records.

22. The query of claim 20, wherein the customized query uniquely associates the user with a Universal User Identification Number.
